(19) United States
(12) Patent Application Publication
(10) Pub. No.: US 2011/0277606 A1
(43) Pub. Date: Nov. 17, 2011

(54) THIN PLATE CUTTING DIE AND A CYLINDER FOR MAGNETICALLY HOLDING THE CUTTING DIE

(75) Inventor: Jonathan Park, Nottinghamshire (GB)

(73) Assignee: GERHARDT LTD, Derby (GB)

(21) Appl. No.: 13/129,033

(22) PCT Filed: Nov. 12, 2009
(86) PCT No.: PCT/IB2009/055034

§ 371 Date: Jul. 21, 2011

(30) Foreign Application Priority Data
Nov. 12, 2008 (EP) 08168874.9

(51) Int. Cl. B26D 7/26; B26F 1/44; B26D 7/01; B26D 7/18

(52) U.S. Cl. 83/100; 83/522.24; 83/331; 83/698.21

(57) ABSTRACT

A thin plate cutting die has on a front surface a closed cutting edge confining an enclosed area and in a back surface a recess. An air-passage through hole is situated within the enclosed area is opening into the recess, and a positioning indication is established for establishing a correct position of the thin plate cutting die. A cylinder for magnetically holding the thin plate cutting die has at least one longitudinal channel extending longitudinally and internally in the cylinder for transferring air, at least one outlet channel extending from the longitudinal channel and opening into a thin plate die receiving surface, and a positioning indication for establishing a correct position of a thin plate cutting die on the receiving surface.

The present invention relates to a thin plate cutting die comprising a flat flexible piece of ferromagnetic sheeting with a front surface and a back surface and comprising at least one closed cutting edge on the front surface said closed cutting edge confining an enclosed area, an air-passage through hole situated within the enclosed area and a positioning indication for establishing a correct position of the thin plate cutting die.

By ferromagnetic sheeting should be understood sheeting of a ferromagnetic material i.e. a material capable of being attracted by a magnet.

Further the invention relates to a cylinder for magnetically holding a thin plate cutting die, said cylinder having an axis of rotation extending in a longitudinal direction, said cylinder comprising two opposite axial ends and a cylindrical receiving surface for receiving a thin plate cutting die, said receiving surface comprising magnetic segments, the further cylinder comprising at least one longitudinal channel extending longitudinally and internally in the cylinder for transferring air, at least one outlet channel extending from the longitudinal channel and opening into the receiving surface, and a positioning indication for establishing a correct position of a thin plate cutting die on the receiving surface.

DE-U-298 05 004 discloses a die cutting cylinder with a cylindrical carrier roller and a thin plate cutting die with a cutting edge provided on the cylindrical mantle surface of the carrier roller, where positioning pins project from the mantle surface and are received in positioning apertures in the thin plate cutting die. The pins are not shown in the drawings, but they are mounted in apertures in the carrier roller. In the mantle surface magnets are imbedded to hold the thin plate cutting die. In the carrier roller near its axis of rotation a longitudinal channel is provided for connection with a vacuum source, and two rows of pinholes are extending from the channel to the mantle surface. In the thin plate cutting die a row of relatively large apertures is provided, each aperture exposing the surface of the carrier roller including a number of the pinholes, whereby cut material within the cutting edge may be held onto the die cutting cylinder by vacuum. This technique of using large apertures in the thin plate cutting die to expose pinholes or air-channels in the surface of the carrier roller is not usable in case of a cutting edge enclosing only a small area. Further exposing a larger part of the surface of the carrier roller may be disadvantageous.

EP-A-0 312 422 discloses a die cutting roller with two half-shells connected around a cylindrical core. One of the half-shells is provided with magnets for holding a (rather small) thin plate cutting die with a cutting edge and apertures for suction or pressurized air. The half-shell has air-channels, which at correct positioning of the thin plate cutting die are brought into alignment with the apertures. The air-channels are shown to have a diameter a little larger than the diameter of the apertures. The air-channels open into an annular channel, which in a manner, not explained in detail, is connectable with a vacuum and a pressure source. An edge provides an abutment for the edge of the thin plate cutting die to ensure correct positioning. This technique requires that the apertures in the thin plate cutting die are placed similar to the air-channels in the surface of the half-shell.

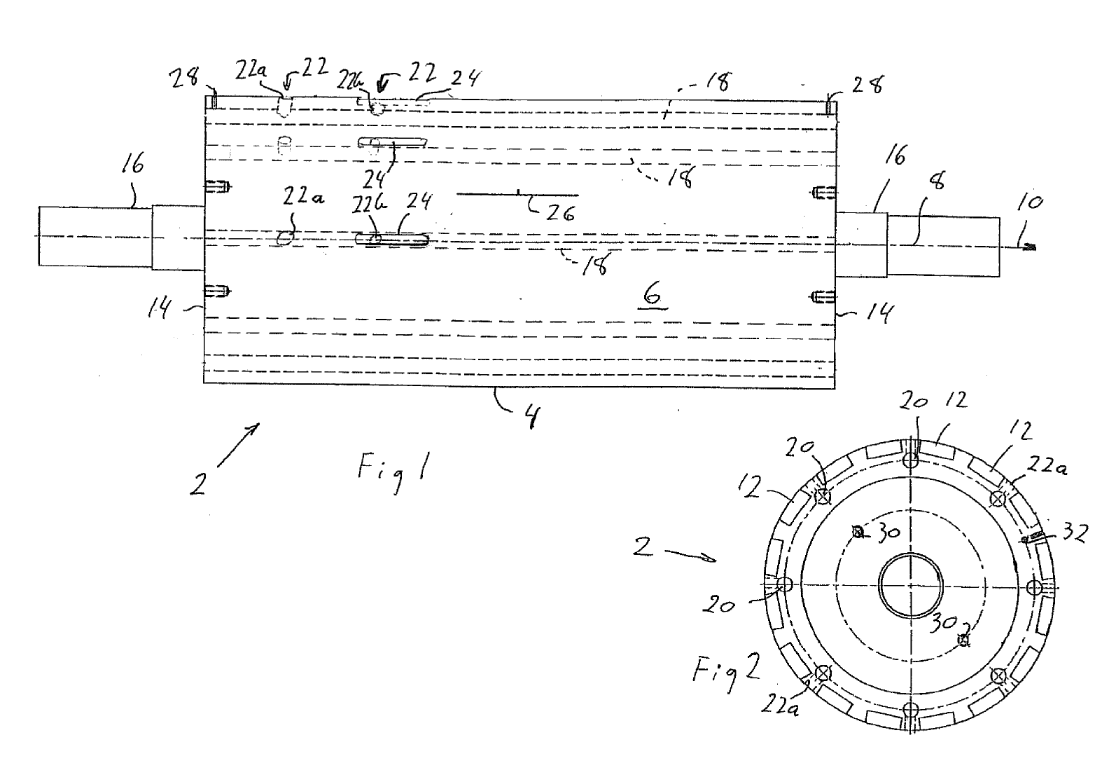

EP-A-0 519 661 discloses a carrier roller with magnets and screws for fastening a thin plate cutting die. Radial air-channels or ports in the carrier roller open into a central channel, which may be connected with a vacuum or a pressure source. It is stated (in relation to FIGS. 1-4) that the ports are in register with cooperating ports (not shown) in the thin plate cutting die. FIG. 8 shows ports in the die having greater diameter than the ports and exposing one or two of such ports, which is similar to the technique used according to the above mentioned DE-U-298 05 004.

EP-A-1 655 118 discloses a carrier roller with magnets and a plurality of apertures provided in rows between the magnets. A thin plate cutting die is provided with openings substantially larger than the apertures, whereby each opening is sure to expose at least one aperture, which is similar to the technique used according to the above mentioned DE-U-298 05 004.

U.S. Pat. No. 3,274,871 discloses a die cutting cylinder comprising a carrier roller provided with a thick shell segment, which again is provided with knife-elements with closed projecting cutting edges. Within the cutting edges is a plurality of apertures, which are aligned with similar apertures in the shell segment, the latter apertures open into recesses in the internal surface of the shell segment formed as wide T- or L-shaped grooves with rectangular cross-section. These recesses are connected with longitudinal channels in the carrier roller through bores. The channels are connected with vacuum and pressure sources. The knife-elements are fastened to the shell segment by means of screws. The recesses extend broadly beneath the cutting edges. The shell segment is a thick-walled element with a load bearing capacity, and not a thin-walled, flexible element like a thin plate cutting die. The shell segment is attached to the carrier roller by means, not shown, such as screws.

EP-A-1 612 009 discloses a die cutting cylinder comprising a tubular mantle with an air distribution mechanism inside. The air distribution mechanism comprises two parts, of which a first tubular part is fixedly mounted inside the tubular mantle and the other part is rotatable inside the first part. The first part has air passages opening into longitudinal grooves, which are distributing air to apertures in the tubular mantle inside and outside a closed cutting edge thereof. Thus, especially the tubular mantle and the first part are dedicated one another, and normally they are fixed to one another by means of a press-fit, glue or other fastening means. It appears that all three elements are thick walled. The cutting die cylinder thus appears as a solid die cutting roller with an internal air distribution system.

U.S. Pat. No. 3,965,786 discloses a thin plate cutting die and a cylinder for magnetically holding a thin plate cutting die as stated above.

U.S. Pat. No. 5,627,505 discloses a magnetic cylinder with axial extending permanent bar magnets.

U.S. Pat. No. 5,687,622 discloses a cutting die produced by photochemical etching and subsequent milling. In one embodiment the cutting die is a thin plate cutting die, which is mounted on a roller or cylinder as a sleeve.

U.S. Pat. No. 3,766,814 discloses an air eject die-cutting assembly comprising a cylinder having on its cylindrical surface closed cutting edges. The cylinder has a central longitudinally extending channel and radial channels extending from the longitudinal channel to the cylindrical surface of the cylinder, where the radial channels have outlet apertures opening within areas confined by the closed cutting edges. An air inlet member in the shape of a hollow tubular core with lateral openings is provided in the longitudinal channel for supplying air to the radial channels when they during rotation pass such lateral opening. Hereby is obtained the pieces of material, e.g. paper, which are cut from a web by means of a closed cutting edge, may at an appropriate time when the die-cutting cylinder is in an appropriate position be blown away from the cylinder by means of air ejected through a respective radial channel in the cylinder.

U.S. Pat. No. 5,452,634 discloses another example of a die-cutting cylinder provide with a central longitudinal channel receiving a tubular member with lateral openings for supplying air to radial channels extending in the die-cutting cylinder from the longitudinal channel to the cylindrical surface of the die-cutting cylinder. The cutting edges are provided on metal inserts removably secured in recesses in the cylindrical surface of the die-cutting cylinder.

U.S. Pat. No. 4,993,293 discloses a die-cutting cylinder comprising several longitudinally extending, eccentric channels, which are connected with respective radial outlet channels opening within areas confined by closed cutting edges on the cylindrical surface of the die-cutting cylinder. At an end of the die-cutting cylinder a ring or fork shaped coupling member is provided for supplying air to the longitudinal channels through inlet openings thereof in a radial surface at the end of the cylinder. In one embodiment the cutting edges are provided on punching segments on a carrier cylinder whereby radial bores or channels in the cylinder coincide with bores in the punching segments. The punching segments are shown to be parts of a tubular member.

DK-U-95 00032 discloses a thin plate cutting die held on a plane magnetic holder. The holder may be mounted in a stamping press for die-cutting sheet material. Three pins extending from the surface of the holder and recesses in opposite edges of the thin plate cutting die ensures the correct position of the cutting die on the holder.

As seen from the above examples of prior art it is on one hand known to provide cutting dies as thin plates, whish may be magnetically held on a holder e.g. in the shape of a cylinder to provide a rotary die-cutting tool with easily exchangeable working part, whereby a worn working part may be exchanged or a fresh one, or a working part with one configuration of its cutting edges may be exchanged with a working part having another configuration if its cutting edges to provide for producing different cuts.

It is on the other hand known to provide channels in a rotary die-cutting tool to provide for ejecting material from the areas confined by cutting edges by means of pressurised air.

Further it is known to provide a magnetic carrier roller having air-channels opening into its mantel surface and a thin plate cutting die having corresponding apertures or larger apertures.

The object of the present invention is to provide a die cutting tool featuring easy exchange of the cutting edges and their configuration together with possibility of providing for ejecting cut material from the cutting edges by means of air, while providing versatility and avoiding the problems of the prior art mentioned above.

This is in a first aspect obtained by a thin plate cutting die as mention by way of introduction, which is characterized in that at least one recess of predetermined dimensions is provided in the back surface, said through hole opening into said recess, the recess covering a larger area of the back surface than the cross-sectional area of the through hole. Hereby is obtained that a thin plate cutting die with air passage holes may be attached to holding cylinder with air passage outlet holes wherein the configuration of the holes of the thin plate cutting die do not exactly correspond to the configuration of the holes of the cylinder as long as the holes of the cylinder are positioned within the boundaries of the respective recesses a the holes of the thin plate cutting die.

The recess preferably provides a shallow basin shaped area.

In a preferred embodiment the recess provides at least two shallow basin shaped areas connected by a groove, a through hole being provided within at least one of the shallow basins shaped areas. Hereby is obtained that a through hole situated in one shallow basin shaped area may be provided with air from another shallow basin shaped area, which covers an air outlet opening in the cylindrical surface of a holding cylinder.

Preferably grooves crossing below cutting edges have a cross-section providing load-carrying capacity, such as an arched cross-section, and the cross-sectional width of the grooves are substantially less than the width of the shallow basins.

In one embodiment the positioning indication is at least one location mark. This will provide for visual control that the thin plate cutting die is placed correctly on a holding cylinder.

In a preferred embodiment the positioning indication comprises at least one positioning recess for receiving a corresponding projection on a holding cylinder. The positioning recess will assure the correct positioning of the thin plate cutting die since a projection on the holding cylinder will otherwise raise the thin plate cutting die from its surface and prevent correct operation. In a further preferred embodiment the positioning recess comprises a pin hole opening into the back surface.

In a second aspect the object is obtained by a cylinder for magnetically holding a thin plate cutting die as also mentioned by way of introduction, said cylinder being characterized in that at least one outlet channel comprises a groove provided in the receiving surface. Preferably such groove extends in the longitudinal direction. Hereby is obtained that thin plate cutting dies having through holes the configuration of which does not correspond exactly with the configuration of the outlet channels of the cylinder may be used.

More outlet channels may connect one longitudinal channel with one groove.

In a practical embodiment the longitudinal channel is placed eccentrically at a distance from the axis of rotation, an inlet opening connected with the longitudinal channel being provided in an annular coupling surface at an end of the cylinder from which the longitudinal channel is extending. In connection herewith a non-rotating coupling member for coupling an air source to said inlet opening may be provided at said end of the cylinder, said coupling member having a coupling surface for abutting the coupling surface of the cylinder, an air-outlet opening being provided in the circular coupling surface of the coupling member. Thereby said air-outlet opening may have a width and a length extending over an angular interval, the length being larger than the width, or said inlet opening may have a width in a radial direction and a length in a circumferential direction extending over an angular interval the length being larger than the width. This provides for ejecting air through holes in a thin plate cutting die over an interval of angular position thus ensuring that ejection takes place a the right time even if the through hole in the thin plate cutting die is circumferentially shifted relative to the opening of the outlet channel in the receiving surface.

Alternatively the longitudinal channel may be placed coaxially with the axis of rotation and a tubular, non-rotating coupling member with a lateral wall may be inserted into the longitudinal channel, said coupling member comprising at least one air-outlet opening in the lateral wall, as it is generally known form the above-mentioned U.S. Pat. No. 3,766,814 and U.S. Pat. No. 5,452,634.

According to a third aspect the invention relates to a die-cutting assembly comprising a thin plate cutting die and a cylinder according to the invention.

In the following the invention will be explained in further detail by means of examples of embodiments with reference to the schematic drawing, in which

FIG. 1 shows a side view of a magnetic cylinder according to the invention,

FIG. 2 shows an end view of the cylinder of FIG. 1,

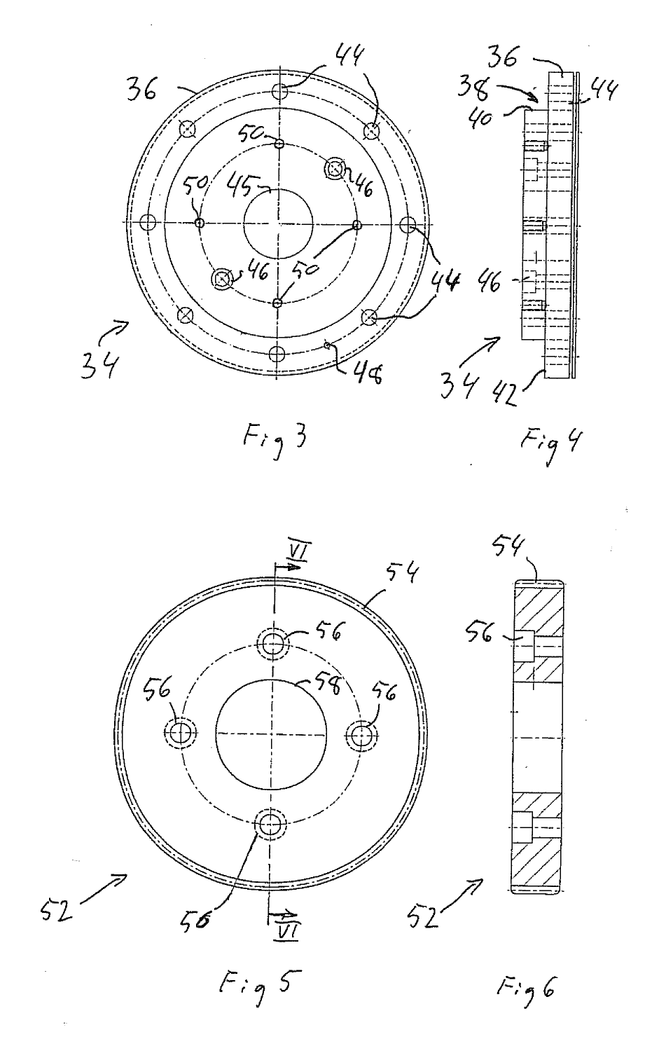

FIG. 3 is an end view of a bearer member,

FIG. 4 is a side view of the bearer member of FIG. 3,

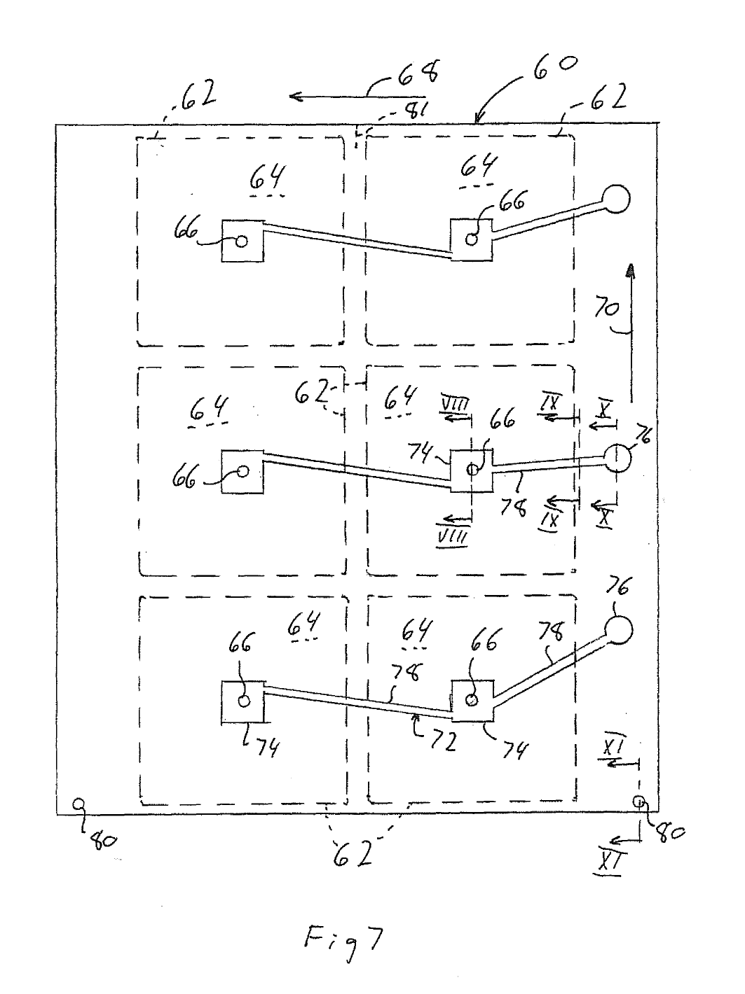

FIG. 5 is an end view of a gearwheel,

FIG. 6 shows a section along line VI-VI in FIG. 5,

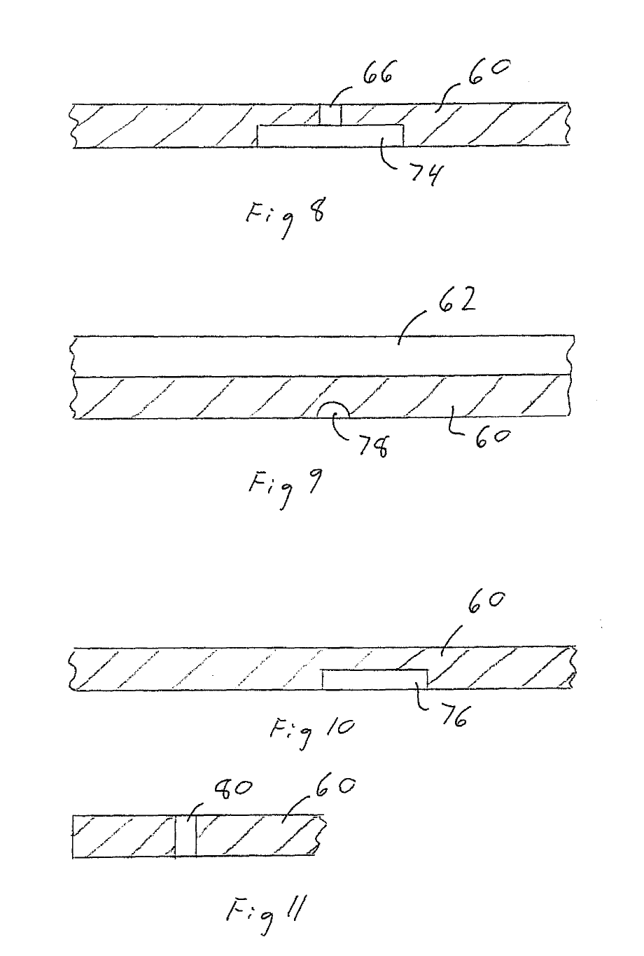

FIG. 7 shows a thin plate cutting die according to the invention from a back side thereof,

FIG. 8 shows a section along line VIII-VIII in FIG. 7,

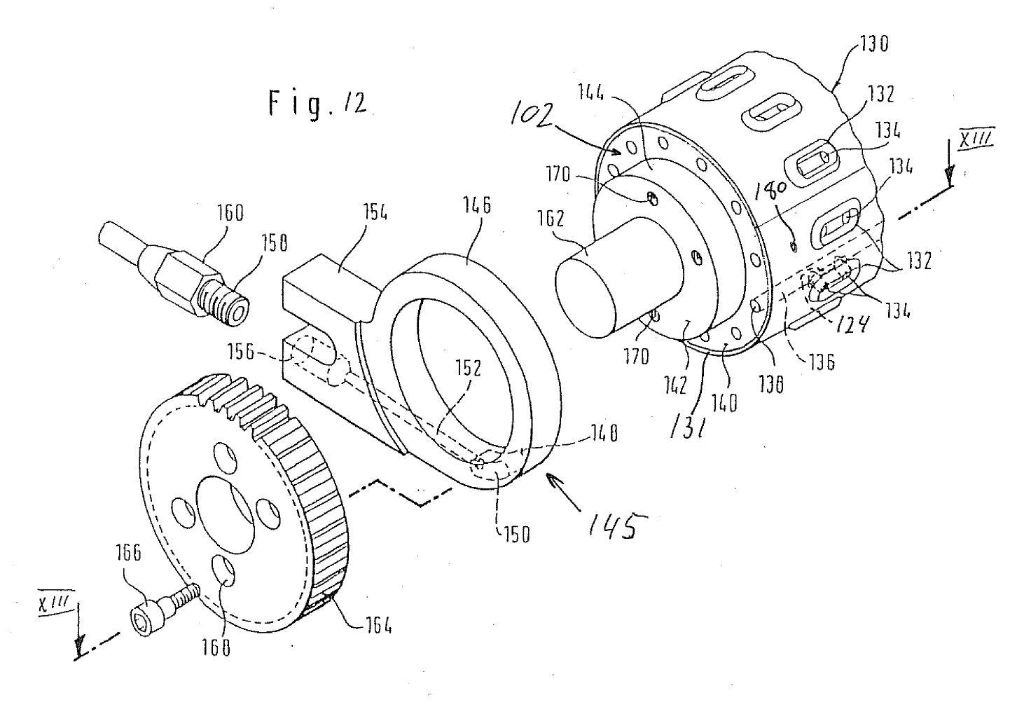

FIG. 9 shows a section along line IX-IX in FIG. 7,

FIG. 10 shows a section along line X-X in FIG. 7,

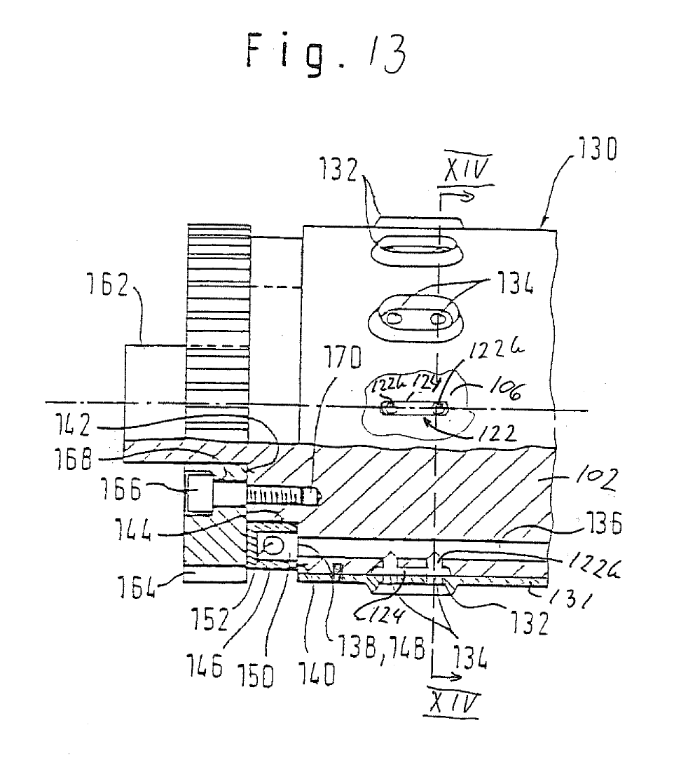

FIG. 11 shows a section along line XI-XI in FIG. 7,

FIG. 12 shows in an exploded representation one end of a die-cutting assembly with a ring interacting with it and a drive gearwheel.

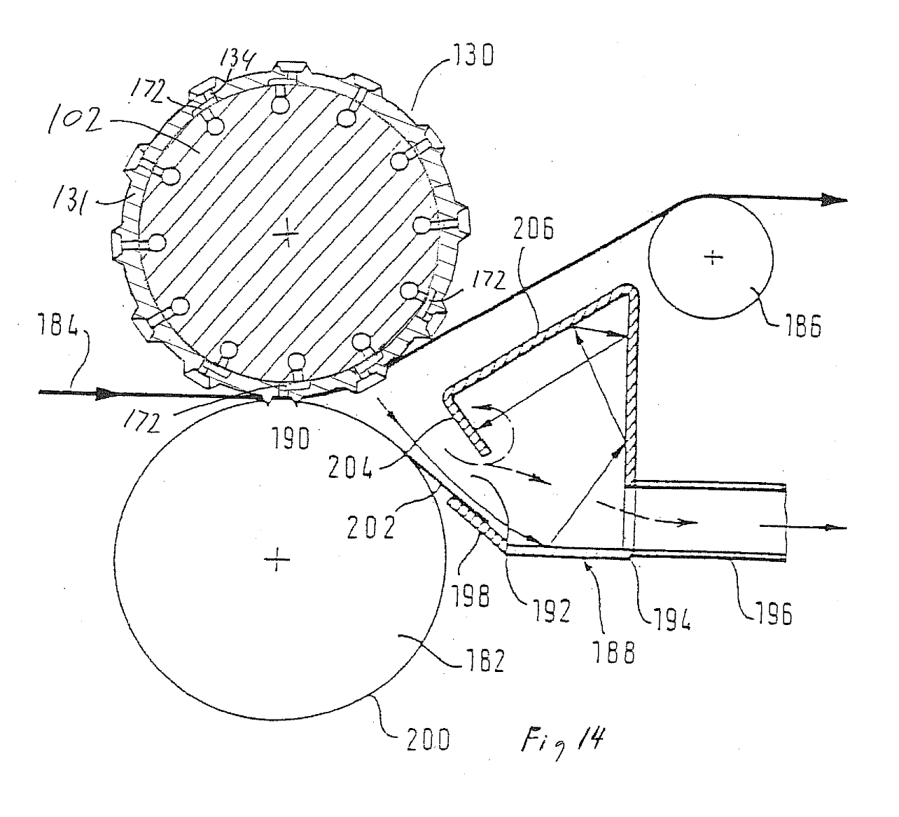

FIG. 13 shows a section along the line XIII-XIII in FIG. 12 after the parts represented in Fig. were mounted together.

FIG. 14 shows a box for receiving the punched-out material in its interaction with the die-cutting assembly of FIG. 13 shown in section as indicated by line XIV-XIV in FIG. 13 and a counterbearing cylinder.

FIGS. 1 and 2 show a magnetic cylinder 2 for magnetically holding a thin plate cutting die. The magnetic cylinder 2 comprises a cylindrical body 4 with a receiving surface 6, an axis 8 of rotation extending in a longitudinal direction 10, magnetic segments 12 embedded in the receiving surface 6, end faces 14 and cylindrical extensions or stub shafts 16 extending coaxially from the end faces 14.

Eight longitudinal channels 18 are in the embodiment shown extending through the length of the cylindrical body 4 having openings 20 in the end faces 14. Outlet channels 22 are provided extending from the longitudinal channels 20 to the receiving surface 6.

FIG. 1 indicates two different sets of outlet channels 22: In a first set each outlet channel comprises a tubular section 22a extending from the respective longitudinal channel 18 to the receiving surface 6. In a second set of outlet channels grooves 24 extending in the longitudinal direction 10 are provided in the receiving surface 6 and tubular sections 22b are extending between respective longitudinal channels 18 and grooves 24. Length of the grooves may be relative short as shown or the grooves may extend over the mayor part of the length of the cylindrical body 4. Usually only one set of outlet channels will be provided in a magnetic cylinder according to the invention.

On the receiving surface 6 a location mark 26 with a location line and a centre indication is provided for facilitating the positioning of a thin plate cutting die.

It however for positioning a thin plate cutting die preferred to use two pins screwed into threaded pinholes 28 in the receiving surface 6, the pins (not shown) thus protruding from the receiving surface 6 as projections on the cylinder 2. Alternatively to screwing the pins into threaded holes the pins might e.g. be received in the holes with a press fit securing the pins or with a looser fit to be secured e.g. by glue.

The end faces 14 comprise two threaded holes 30 and a threaded pinhole 32.

FIGS. 3 and 4 show a bearer member 34 with a bearing surface 36, a recessed portion 38 providing a circumferential surface 40 and a lateral annular surface 42. Through holes 44 are provided corresponding to the openings 20 of the longitudinal channels 18 in the magnetic cylinder 2 shown in FIGS. 1 and 2. A through centre hole 45 corresponding to the stub shaft 16 and countersunk screw-receiving through holes 46 corresponding to the threaded holes 30, and a pinhole 48 corresponding to the pinhole 32 in the end face 14 are also provided. Finally four threaded holes 50 are provided.

A bearer member 34 may be mounted on either end face 14 of the magnetic cylinder 2 by means of screws (not shown) passing through the holes 46 in the bearer member 34 and into the threaded holes 30 in the end faces 14. A pin mounted in the pinhole 32 in the respective end face 14 will be received by the respective pinhole 48 ensuring the correct positioning of the bearer member 34 on the magnetic cylinder 2. The bearing surfaces 36 of the bearer members 34 will thus provide bearing surfaces at the ends of the magnetic cylinder as known in the art. Further the recessed portion provides for receipt of a coupling member as will be explained with reference to FIGS. 12 and 13.

FIGS. 5 and 6 show a gearwheel 52 comprising a circumferential cogging 54, four countersunk screw-receiving through holes 56 and a centre hole 58 for receiving a stub shaft 16 of the magnetic cylinder 2. The gearwheel 52 may be mounted on a bearer member 34 mounted on the magnetic cylinder 2 by means of screws (not shown) passing through the holes 56 in the gearwheel 52 to be received in respective threaded holes 50 in the bearer member 34. The gearwheel 52 will thus provide for rotationally driving the magnetic cylinder 2 as it is generally known in the art. Further the gearwheel 52 will secure a coupling member received on the circumferential surface 40 of the bearer member 34 as will be explained with reference to FIGS. 12 and 13.

FIGS. 7 to 11 show a thin plate cutting die 60 made from a usual ferromagnetic steel sheet material as it is known in the art. The thin plate cutting die 60, which in FIG. 7 is seen from the back side, is on its front side provided with six closed cutting edges 62 each confining an enclosed square area 64, in which a through hole 66 is provided. In use the thin plate cutting die 60 will be attached to magnetic cylinder, like the one shown in FIGS. 1 and 2, and thus the thin plate cutting die 60 has a longitudinal direction 68 parallel to the longitudinal direction 10 of the magnetic cylinder 2 and a circumferential direction 70 corresponding to the circumference of the magnetic cylinder 2 onto which the thin plate cutting die 60 will be wound to be attached thereto.

At each set of neighbouring through holes 66, as seen in the longitudinal direction 68 a recess 72 is provided said recess comprising a shallow square basin 74 around each through hole 66, a shallow air receiving basin 76 and grooves 78 connecting the respective basins 74, 76. As seen in FIG. 7 the shallow square basins 74 are totally positioned within the respective square area 64. As seen in FIG. 9 the grooves 78, which are crossing below the cutting edges 62, has an arched cross-section providing load-carrying capacity. Further as seen in FIGS. 7-10 the cross-sectional width of the grooves 78 are substantially less than the width of the shallow basins 74 and 76.

Further the thin plate cutting die 60 comprises two recesses in the shape of pinholes 80 and it may on the front side comprise a centre indicating mark 81 as a location mark to facilitate positioning the thin plate cutting die 60 on a magnetic cylinder comprising a corresponding location mark 26.

For use the thin plate cutting die 60 will be wound onto the magnetic cylinder 2 to provide a die-cutting assembly or die-cutting roll. It should here be noted that the thin plate cutting die 60 shown in FIGS. 7 to 11 is intended for a magnetic cylinder comprising a set of outlet channel like the one comprising the tubular section 22a.

Applying the thin plate cutting die 60 the magnetic cylinder 2 the pinholes 80 will function as positioning indication and receive pins attached to the threaded pinholes 28 in the receiving surface 6. The three air receiving basins 76 will cover the openings of respective tubular sections 22a to receive air therefrom.

It is noted that the magnetic cylinder 2 comprises eight longitudinal channels 18 evenly spaced over the circumference (and placed at a specific distance from the central longitudinal axis), but the thin plate cutting die 60 comprise three sets of neighbouring closed cutting edges 62 and thus three recesses 72 with air receiving basins 76. As eight is not a multiple of three the air receiving basins 76 are not evenly spaced in the circumferential direction as the cutting edges 62 are, and the air receiving basins 76 are at different levels relative to their respective cutting edges 62.

As only three of the eight longitudinal channels 18 will thus be used the residual five longitudinal channels should be inactivated. This may be done by blocking their respective opening 20 at one of the ends of the magnetic cylinder 2. At the opposite end of the magnetic cylinder 2 all openings should be blocked not to allow air introduced through the opening 20 in one end of a longitudinal channel 18 to exit through the opening in the opposite end. Blocking of the openings may be performed in various ways: e.g. a bearer member comprising only the through holes 44 corresponding to the openings 20 wanted unblocked may be applied or the longitudinal channels 18 may at their openings 20 be threaded to receive blocking headless screws.

It should be noted that as in the embodiment described so far, only one set of outlet channels 22 are used, and as this set of outlet channels is placed relative close to one of the ends of the magnetic cylinder 2, the longitudinal channels might extend only from the adjacent end face 14 to the outlet channels 22.

FIGS. 12 and 13 show another embodiment of a die-cutting assembly or die-cutting roll 130 comprising a magnetic cylinder 102 and a thin plate cutting die 131 with projecting, closed cutting edges 132, within which outlet openings 134 for compressed air open out. The thin plate cutting die 131 comprise a pinhole 180 receiving a projection (a pin, not shown) on the magnetic cylinder 102. Outlet channels 122 connect longitudinal channels 136 with the receiving surface 106 (shown by cut-away in FIG. 13) of the magnetic cylinder 102. The outlet channels 122 comprise longitudinal grooves 124 and tubular sections 122b as best seen in FIG. 13. The magnetic cylinder 102 comprises 12 evenly circumferentially spaced longitudinal channels 136. The thin plate cutting die 131 likewise comprises 12 closed cutting edges 132, but these are not evenly spaced circumferentially. To compensate, at some of the closed cutting edges 132 the through holes or outlet openings 134 are on the back side provided with a recess 172 with a circumferential extension to cover the adjacent outlet channel 122. In use compressed air is fed to the outlet openings 134 via the longitudinal channels 136, which have inlet openings 138 on a lateral annular face 140 of the magnetic cylinder 102. The annular face 140 encloses a cylinder extension 142 on the magnetic cylinder 102, the circumferential surface 144 of which extension is the bearing surface for a non-rotating coupling member 145 with an annular part 146. In the side face 148 facing the annular face 140 there opens out an air outlet opening 150, which is elongate in the circumferential direction of the die-cutting roll 130 and from which compressed air is to be fed successively to the inlet openings 138 via a channel 152 located in the annular part 146. A fork part 154, serving for assembly, is integrally attached to the annular part 146. The channel 152 ends on the inlet side in an internally threaded section 156, which can receive an externally threaded extension 158 on a compressed air feed part 160. On the cylindrical extension 142 there is a second cylindrical extension 162 of reduced diameter, onto which a gearwheel 164 can be fitted. The gearwheel 164 is to be firmly screwed into threaded holes 170 in the end face of the cylindrical extension 142 by means of screws 166, which pass through holes 168 in the gearwheel 164.

FIG. 14 shows the die-cutting roll 130, which interacts with a rotatably mounted counterbearing cylinder 182, arranged underneath it. It should be noted that the die-cutting roll 130 and the counterbearing cylfinder 182 are both provided with bearing surfaces, not shown but e.g arranged as disclosed in relation to FIGS. 1 to 4, the bearing surfaces of the die-cutting roll 130 and the counterbearing cylinder 182, respectively, bearing on each other to maintain a determined distance between the die-cutting roll 130 and the counterbearing cylinder 182, as it is known in the art. Material 184 in sheet form which is to be punched out is passed through a gap between the die-cutting roll 130 and the counter-bearing cylinder 182 and subsequently removed upwards at an angle over a rotatably mounted supporting roll 186. A box 188 with an entry slit 192, directed at the respectively pressurized outlet openings 190 of the die-cutting roll 180, is provided for receiving and passing on the areas of material punched out from the material 184 in sheet form.

During operation pieces of the material 184 are punched out by the closed cutting edges 132. Soon after a closed cutting edge 132 has left the gab air should be blown through the through holes or outlet openings 134 to expel the punched out piece of material to the box 188. However if air is introduced into the respective longitudinal channels 136 when in a specific angular position, the air will not always be blown from the respective outlet opening 134 at a corresponding angular position because some of the closed cutting edges 132 and therewith their outlet openings 134 are shifted circumferentially relative to the longitudinal channels 136. This is compensated for by the elongation of the air outlet opening 150. Due to this elongation for some closed cutting edges 132 the air will appear to soon while the closed cutting edge is still in the gap and the cut material is blocked by the counterbearing cylinder 182 from leaving the closed cutting edge. However, due to the elongation of the air outlet opening 150 the air will continue to flow for a while, and the cut piece of material will be expelled when the closed cutting edge has left the gab.

The box 188 is designed on the inside as a type of labyrinth, on the inside surfaces of which box the punched-out areas of material are multiply reflected, as indicated by solid arrows. Compressed air draws through the box partly in a swirled form, as indicated by broken arrows. An extraction stub 196 for the punched-out areas of material opens out above a bottom region 194 of the box 188, which extraction stub is connected to an extraction device (not shown).

The entry slit 192 is bounded at the bottom by a wall 198, directed upwards at an angle approximately tangentially to the counter-bearing cylinder 182, on which wall a wiper 202, scraping off the circumferential surface 200 of the counterbearing cylinder 182, is attached. At the top, the entry slit 192 of the box is bounded by a wall 204, pointing away from the die-cutting roll 180, which wall forms in cross section with the wall 206 adjoining it of the box 188 approximately an L.

Referring to the embodiment of a die-cutting assembly disclosed with reference to FIGS. 1 to 11 it is noted that it may be used with a non-rotating coupling member like the non-rotating coupling member 145 in a set-up as disclosed with reference to FIGS. 12 to 14, where the elongated air outlet opening 150 will entail the benefits discussed above. During operation air will flow into a respective longitudinal channel 18, through the tubular section 22a and into the respective air receiving basin 76. From there the air will flow through the groove 78 to the adjacent square basin 74 the presence of which facilitate separation of the air-flow into two streams, one of which flows out through the through hole 66 while the other flow through the groove 78 to the next square basin 74 and out through the through hole 66 of that basin.

It should be understood that the invention is not limited to the embodiments disclosed with reference to the drawings. Several amendments may be made within the scope of the claims. Thus instead of several longitudinal channels placed at a distance from the axis of rotation of the magnetic cylinder and the coupling member abutting an external surface like the lateral annular face 140 a single central channel and a tubular coupling member might be used as it is known from the art. Further, when using a coupling member abutting an external surface, e.g. a circumferential annular face could be used when e.g. radial channels were present to connect outlet openings in such face with a respective longitudinal channel, which in that case should be blocked at its end. It should also be understood that the non-rotating coupling member need not have an annular part: Other means might be provided for holding the coupling member in place. Only is should comprise a face containing the air outlet opening, which face should be able to abut substantially sealingly against a corresponding face on the die-cutting assembly.

1. A thin plate cutting die comprising a flat flexible piece of ferromagnetic sheeting with a front surface and a back surface and comprising at least one closed cutting edge on the front surface said closed cutting edge confining an enclosed area, an air-passage through hole situated within the enclosed area and a positioning indication for establishing a correct position of the thin plate cutting die, wherein at least one recess of predetermined dimensions is provided in the back surface, said through hole opening into said recess, the recess covering a larger area of the back surface than the cross-sectional area of the through hole.

2. A thin plate cutting die according to claim 1, wherein the recess provides a shallow basin shaped area.

3. A thin plate cutting die according to 2, wherein the recess comprises the shallow basin shaped area and a groove opening into the shallow basin shaped area, the groove having a smaller cross-sectional width than the shallow basin shaped area.

4. A thin plate cutting die according to claim 2, wherein the recess provides at least two shallow basin shaped areas connected by a groove, a through hole being provided within at least one of the shallow basins shaped areas.

5. A thin plate cutting die according to claim 1, wherein said positioning indication is at least one location mark.

6. A thin plate cutting die according to claim 1, wherein said positioning indication comprises at least one positioning recess for receiving a corresponding projection on a holding cylinder.

7. A thin plate cutting die according to claim 6, wherein said positioning recess comprises a pin hole opening into the back surface.

8. A cylinder for magnetically holding a thin plate cutting die, said cylinder having an axis of rotation extending in a longitudinal direction, said cylinder comprising two opposite axial ends and a cylindrical receiving surface for receiving a thin plate cutting die, said receiving surface comprising magnetic segments, the further cylinder comprising at least one longitudinal channel extending longitudinally and internally in the cylinder for transferring air, at least one outlet channel extending from the longitudinal channel and opening into the receiving surface, and a positioning indication for establishing a correct position of a thin plate cutting die on the receiving surface, wherein at least one outlet channel comprises a groove provided in the receiving surface.

9. A cylinder according to claim 8, wherein said groove extends in the longitudinal direction.

10. A cylinder according to claim 8, wherein the longitudinal channel is placed eccentrically at a distance from the axis of rotation, an inlet opening connected with the longitudinal channel being provided in an annular coupling surface at an end of the cylinder from which the longitudinal channel is extending.

11. A cylinder according to claim 10, wherein a non-rotating coupling member for coupling an air source to said inlet opening is provided at said end of the cylinder, said coupling member having a coupling surface for abutting the coupling surface of the cylinder, an air-outlet opening being provided in the coupling surface of the coupling member.

12. A cylinder according to claim 11, wherein said air-outlet opening has a width and a length extending over an angular interval, the length being larger than the width.

13. A cylinder according to claim 11, wherein said inlet opening has a width in a radial direction and a length in a circumferential direction extending over an angular interval the length being larger than the width.

14. A cylinder according to claim 8, wherein the longitudinal channel is placed coaxially with the axis of rotation and that a tubular, non-rotating coupling member with a lateral wall is inserted into the longitudinal channel, said coupling member comprising at least one air-outlet opening in the lateral wall.

15. A die-cutting assembly comprising a thin plate cutting die according to claim 1 and a cylinder for magnetically holding a thin plate cutting die, said cylinder having an axis of rotation extending in a longitudinal direction, said cylinder comprising two opposite axial ends and a cylindrical receiving surface for receiving a thin plate cutting die, said receiving surface comprising magnetic segments, the further cylinder comprising at least one longitudinal channel extending longitudinally and internally in the cylinder for transferring air, at least one outlet channel extending from the longitudinal channel and opening into the receiving surface, and a positioning indication for establishing a correct position of a thin plate cutting die on the receiving surface.

16. A die-cutting assembly according to claim 15 comprising a cylinder for magnetically holding a thin plate cutting die, said cylinder having an axis of rotation extending in a longitudinal direction, said cylinder comprising two opposite axial ends and a cylindrical receiving surface for receiving a thin plate cutting die, said receiving surface comprising magnetic segments, the further cylinder comprising at least one longitudinal channel extending longitudinally and internally in the cylinder for transferring air, at least one outlet channel extending from the longitudinal channel and opening into the receiving surface, and a positioning indication for establishing a correct position of a thin plate cutting die on the receiving surface, wherein at least one outlet channel comprises a groove provided in the receiving surface.
